(19) United States
(12) Patent Application Publication
(10) Pub. No.: US 2020/0057933 A1
(43) Pub. Date: Feb. 20, 2020

(54) NEURAL NETWORK PREDICTING COMMUNICATIONS NETWORK INFRASTRUCTURE OUTAGES BASED ON FORECASTED PERFORMANCE METRICS

(71) Applicant: CA, Inc., New York, NY (US)

(72) Inventors: David Cosgrove, Portsmouth, NH (US); Michelle Cross, Lee, NH (US)

(73) Assignee: CA, Inc., New York, NY (US)

(21) Appl. No.: 16/103,664

(22) Filed: Aug. 14, 2018

(51) Int. Cl. G06N 3/04; G06N 3/08

(52) U.S. Cl. CPC G06N 3/04; G06N 3/08

(57) ABSTRACT

A network metrics repository stores performance metrics measured during operation of a communication network, and stores fault values indicating types of network operation faults. A neural network circuit has an input layer having input nodes, a sequence of hidden layers each having a plurality of combining nodes, and an output layer having an output node. A processor generates forecasted performance metrics based on extrapolating from measured performance metrics in the network metrics repository, and provides to the input nodes of the neural network circuit the forecasted performance metrics and the measured performance metrics. The processor adapts weights and/or firing thresholds that are used by the input nodes responsive to output of the output node, and controls operation of the communication network based on output of the output node. The output node provides the output responsive to processing through the input nodes a stream of measured performance metrics and forecasted performance metrics.

### BACKGROUND

The present disclosure relates to communications network infrastructure management.

Communications network infrastructure management products usually present historical outage data for monitored elements of a network infrastructure. Some products provide predictive outage capabilities, however the outage prediction is based on linear regressions performed on historical outage counts. These products have a limited ability to accurately predict communications network infrastructure outages before they occur.

### SUMMARY

Some embodiments disclosed herein are directed to a network management computer system that includes a network metrics repository, a neural network circuit, and at least one processor. The network metrics repository stores performance metrics that are measured during operation of a communication network, and stores fault values which indicate whether defined types of network operation faults have occurred. The neural network circuit has an input layer having input nodes, a sequence of hidden layers each having a plurality of combining nodes, and an output layer having an output node. The at least one processor is coupled to the network metrics repository and to the neural network circuit. The at least one processor is configured to generate forecasted performance metrics based on extrapolating from measured performance metrics in the network metrics repository, and to provide, to the input nodes of the neural network circuit, the forecasted performance metrics and the measured performance metrics. The at least one processor further adapts weights and/or firing thresholds that are used by at least the input nodes of the neural network circuit responsive to output of the output node of the neural network circuit, and controls operation of the communication network based on output of the output node of the neural network circuit. The output node provides the output responsive to processing through the input nodes of the neural network circuit a stream of measured performance metrics and forecasted performance metrics that are obtained during operation of the communication network.

The network management computer system may perform with an improved ability to accurately predict communications network infrastructure outages before they occur, due to it generating the forecasted performance metrics based on the extrapolation from the measured performance metrics in the network metrics repository, and due to it providing to the input nodes of the neural network circuit the forecasted performance metrics and the measured performance metrics. Accordingly, the neural network circuit operates to respond to a combination of the measured performance metrics and the forecasted performance metrics.

Some other related embodiments are directed to a computer program product that includes a non-transitory computer readable storage medium having computer readable program code stored in the medium and when executed by at least one processor of a network management computer system causes the network management computer system to perform operations. The operations include accessing a network metrics repository to retrieve performance metrics that are measured during operation of a communication network, and to retrieve fault values which indicate whether defined types of network operation faults have occurred. The operations further include generating forecasted performance metrics based on extrapolating from the measured performance metrics, and include providing to input nodes of a neural network circuit the forecasted performance metrics and the measured performance metrics. The operations further include adapting weights and/or firing thresholds that are used by at least the input nodes of the neural network circuit responsive to output of an output node of the neural network circuit, and include controlling operation of the communication network based on output of the output node of the neural network circuit. The output node provides the output responsive to processing through the input nodes of the neural network circuit a stream of measured performance metrics and forecasted performance metrics that are obtained during operation of the communication network.

Some other related embodiments are directed to a correspondence method by a network management computer system.

Other systems, computer program products, and methods according to embodiments will be or become apparent to one with skill in the art upon review of the following drawings and detailed description. It is intended that all such additional systems, computer program products, and methods be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 illustrates a network management computer system that monitors operation of a communication network in accordance with some embodiments.

FIG. 2 illustrates an operational view of the network management computer system that is processing the measured performance metrics of the network nodes of the communications network in accordance with some embodiments.

FIGS. 3 illustrates elements of the neural network circuit which are interconnected and configured to operate in accordance with some embodiments.

FIG. 4 is a flowchart of operations that may be performed by the network management computer system in accordance with some embodiments.

FIG. 5 is a block diagram and data flow diagram of a neural network circuit that can be used in the network management computer system to generate a network operation fault prediction and perform feedback training of the node weights and firing thresholds of the layers of the neural network, in accordance with some embodiments.

FIG. 6 is a flowchart of operations that may be performed by the network management computer system in accordance with some embodiments.

FIG. 7 is a flowchart of operations of remedial actions that may be performed by the network management computer system in accordance with some embodiments.

FIG. 8 is a block diagram of operational modules and related circuits and controllers of the network management computer system that are configured to operate during the run-time mode in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Some embodiments of the present disclosure are directed to a network management computer system that uses a combination of measured performance metrics and forecasted performance metrics for a communication network as inputs to a neural network that predicts occurrence of communication network faults. A network controller uses output of the neural network and, in particular, indications of communication network faults to control operation of the communication network. Using forecasted performance metrics to predict communication network faults can enable responsive actions to be performed before network outages or undesirable communication performance degradation occurs.

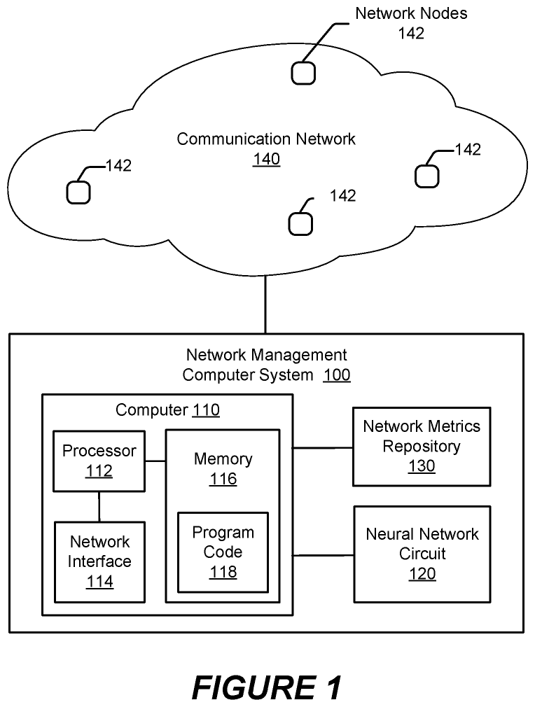

FIG. 1 illustrates a network management computer system 100 that monitors operation of a communication network 140. The network management computer system 100 includes a network metrics repository 130, a neural network circuit 120, and a computer 110. The computer 110 includes at least one memory 116 (“memory”) storing program code 118, a network interface 114, and at least one processor 112 (“processor”) that executes the program code 118 to perform operations described herein. The computer 110 is coupled to the network metrics repository 130 and the neural network circuit 120. The network management computer system 100 can be connected to monitor a communication network 140 that includes a plurality of network nodes 142 that receive and forward communication packets being communicated through the network (i.e., between network edge nodes, packet router nodes, etc.). More particularly, the processor 112 can be connected via the network interface 114 to communicate with the network nodes 142 and the network metrics repository 130.

The processor 112 may include one or more data processing circuits, such as a general purpose and/or special purpose processor (e.g., microprocessor and/or digital signal processor) that may be collocated or distributed across one or more networks. The processor 112 may include one or more instruction processor cores. The processor 112 is configured to execute computer program code 118 in the memory 116, described below as a non-transitory computer readable medium, to perform at least some of the operations described herein as being performed by any one or more elements of the network management computer system 100.

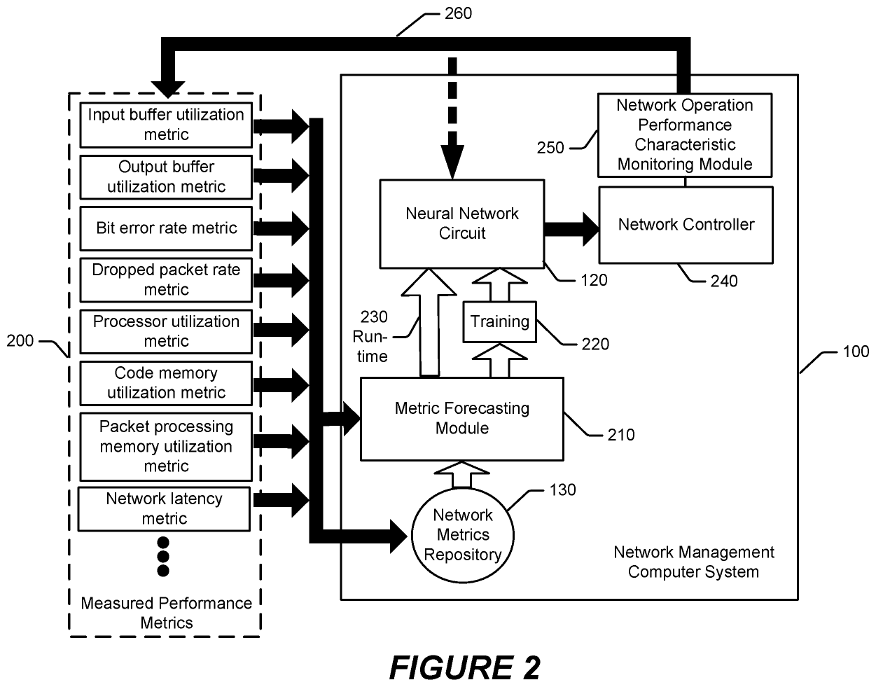

FIG. 2 illustrates an operational view of the network management computer system 100 that is processing the measured performance metrics 200 of the network nodes 142 of the communications network 140.

Referring to FIG. 2, a network operation performance characteristic monitoring module 250 can operate to monitor performance characteristics of the network nodes 142 (e.g., measure performance of the network nodes or receive measurements from the network nodes) to generate various defined types of measured performance metrics therefrom. The measured performance metrics 200 that can be generated 260 for each of the network node 142 and input to the network management computer system 100 for processing, can include, without limitation, input buffer utilization metric indicating utilization of a network packet input buffer of the network node 142, output buffer utilization metric indicating utilization of a network packet output buffer of the network node 142, a bit error rate metric indicating a bit error rate in network packets processed by the network node 142, a dropped packet metric indicating a rate of network packets that are dropped without being forwarding by the network node 142, a processor utilization metric indicating processor utilization of the network node 142, code memory utilization metric indicating utilization of a portion of the memory of the network node 142 that stores program code, packet processing memory utilization metric indicating utilization of a portion of the memory of the network node 142 that is allocated for processing network packets, network latency metric indicating latency caused by the network node 142 between receipt and forwarding of network packets, etc.

The measured performance metrics 200 can be input to the network metrics repository 130 for storage and may also be input to a metric forecasting module 210. The network metrics repository 130 may also store fault values which indicate whether defined types of network operation faults have occurred with identified ones of the network nodes 142. The metric forecasting module 210 operates to generate forecasted performance metrics based on extrapolating from the measured performance metrics 200, which may be obtained from the network metrics repository 130.

During a runtime mode 230, the forecasted performance metrics from the metric forecasting module 210 and the measured performance metrics 200 are provided to input nodes of the neural network circuit 120. The neural network circuit 120 processes the inputs to the input nodes through neural network hidden layers which combine the inputs, as will be described below, to provide outputs for combining by an output node. The output node provides an output value responsive to processing through the input nodes of the neural network circuit a stream of measured performance metrics and forecasted performance metrics that are obtained during operation of the communication network 140. The value output by the output node of the neural network 120 may function as a network operation fault prediction which is used by the network controller 240 to control operation of the network nodes 142 of the communication network 140 to trigger remedial actions when the network operation fault prediction value satisfy one or more defined remedial action rules.

As will be explained in further detail below, the network controller 240 may trigger remedial operations, such as shifting communication packet traffic away from other network nodes toward another network node responsive to the output value from the neural network output node satisfying a remedial action rule. Alternatively or additionally, the network controller 240 may communicate a command to a network node instructing the network node to reboot at least a portion of executable operational code of the network node responsive to the output value from the neural network output node satisfying the remedial action rule. Still alternatively or additionally, the network controller 240 may communicate and alert notification toward an operator module responsive to the output value from the neural network output node satisfying the remedial action rule.

During a training mode, a training module 220 adapt weights and/or firing thresholds that are used by at least the input nodes of the neural network circuit 120 responsive to output of the output node of the neural network circuit.

As will be explained in further detail below, in one embodiment, the training module 220 operates to use the forecasted performance metrics from the metric forecasting module 210 and the measured performance metrics 200 to adapt the weights and/or firing thresholds are used by input nodes and which may also be used by nodes of the neural network hidden layers.

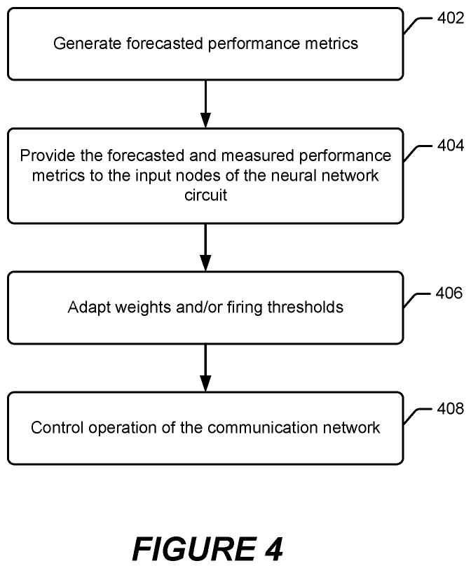

FIG. 4 is a flowchart of operations it may be performed by the network management computer system 100 in accordance with some embodiments. Referring to FIG. 4, the system 100 generates 402 forecasted performance metrics based on extrapolating from measured performance metrics in the network metrics repository, and provides 404 the forecasted performance metrics and the measured performance metrics to the input nodes of the neural network circuit 120. The operations further include adapting 406 weights and/or firing thresholds that are used by at least the input nodes of the neural network circuit 120 responsive to output of the output node of the neural network circuit. The operations further include controlling 408 operation of one or more of the network nodes 142 of the communications network 140 based on output of the output node of the neural network circuit 120. The output node provides the output responsive to processing through the input nodes of the neural network circuit 120 a stream of measured performance metrics and forecasted performance metrics that are obtained, e.g., by the network operation performance characteristic monitoring module 250, during operation of the communications network 140.

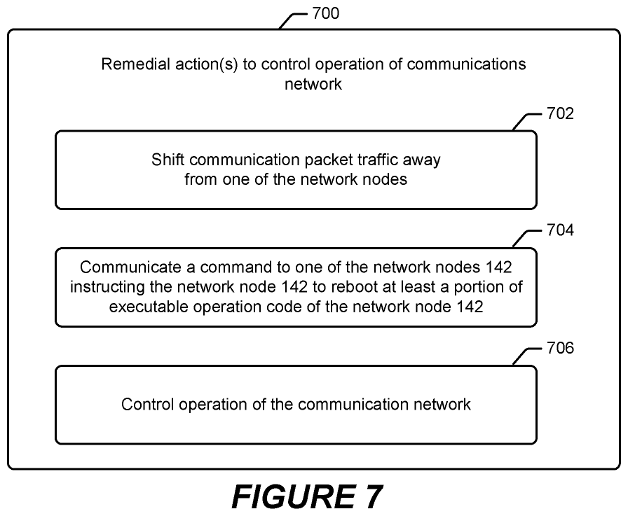

Various remedial actions 700 that can be performed by at least one processor of the network management computer system 100, such as by the network controller 240, during operation of the run-time mode 230 are illustrated by the flowchart of FIG. 7. These operations are explained in the context of the communications network 140 including network nodes 142 that receive and forward communication packets.

One illustrative remedial action that can be performed to control 408 operation of the communications network 140 includes shifting 702 communication packet traffic away from one of the network nodes 142 toward one or more other ones of the network node 142′ responsive to the measured performance metrics characterizing operation of the network node and the output of the output node of the neural network circuit 120 indicating at least a threshold likelihood of a fault in operation of the network node 142. Accordingly, when the network operation fault prediction value satisfies a remedial action rule, one of the network nodes 142 which is forecasted to have an operational problem can have its packet traffic processing load reduced to avoid occurrence of a fault or other degraded performance. The remedial action may include shifting all packet traffic away from that network node so that other network nodes take over its packet traffic handling responsibilities while it is, for example, rebooted or taken off-line for other repair.

Another remedial action that can be performed to control 408 operation of the communications network 140 includes communicating 704 a command to one of the network nodes 142 instructing the network node 142 to reboot at least a portion of executable operation code of the network node 142, responsive to the measured performance metrics characterizing operation of the network node 142 and the output of the output node of the neural network circuit 120 indicating at least a threshold likelihood of a fault in operation of the network node 142.

Still another remedial action that can be performed to control 408 operation of the communications network 140 includes communicating 706 an alert notification toward an operator console which indicates that an identified network node 142 has an operational fault, responsive to the measured performance metrics characterizing operation of the identified network node 142 and the output of the output node of the neural network circuit 120 indicating at least a threshold likelihood of a fault in operation of the identified network node 142.

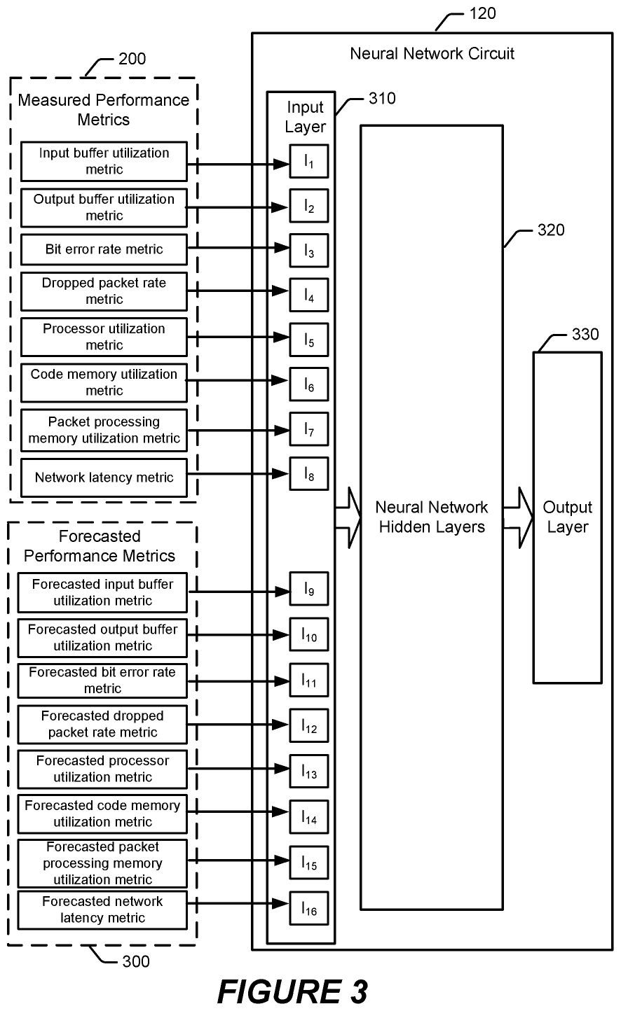

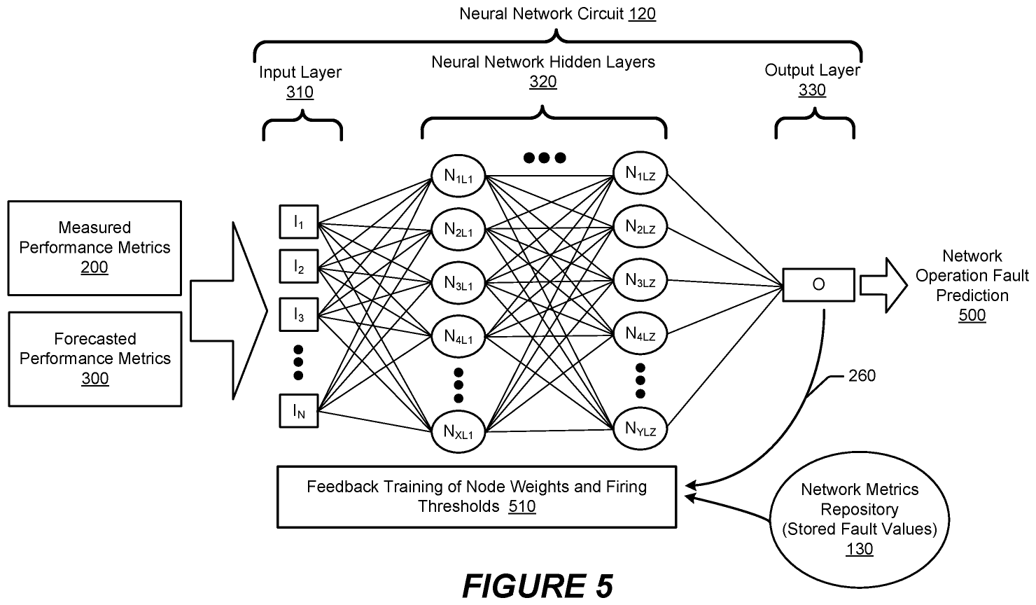

FIGS. 3 illustrates that the neural network circuit 120 can include an input layer 310 with input nodes “I”, a sequence of hidden layers 320 each having a plurality of combining nodes, and an output layer 330 having an output node. Each of the input nodes “I” can be connected to receive a different type of the measured performance metrics 200 and the forecasted performance metrics, such as shown in FIG. 3. Example operations of the combining nodes and output node are described in further detail below with regard to FIG. 5.

In the non-limiting illustrative embodiment of FIG. 3, the metric forecasting module 210 has generated forecasted performance metrics 300 which are at least based on earlier metrics from the measured performance metrics 200. For example, the forecasted performance metrics 300 can include a forecasted input buffer utilization metric which is at least based on a sequence of earlier input buffer utilization metrics, a forecasted output buffer utilization metric which is at least based on a sequence of earlier output buffer utilization metrics, a forecasted bit error rate metric which is at least based on a sequence of earlier forecasted bit error rate metrics, a forecasted dropped packet rate metric which is at least based on a sequence of earlier forecasted dropped packet rate metrics, a forecasted process utilization metric which is at least based on a sequence of earlier forecasted processor utilization metrics, a forecasted code memory utilization metric which is at least based on a sequence of earlier forecasted code memory utilization metrics, forecasted packet processing memory utilization metric which is at least based on a sequence of earlier forecasted packet processing memory utilization metrics, and forecasted network latency metric which is at least based on a sequence of earlier forecasted network latency metrics.

Various operations that may be performed by the metric forecasting module 210 to generate the forecasted performance metrics 300 will now be explained.

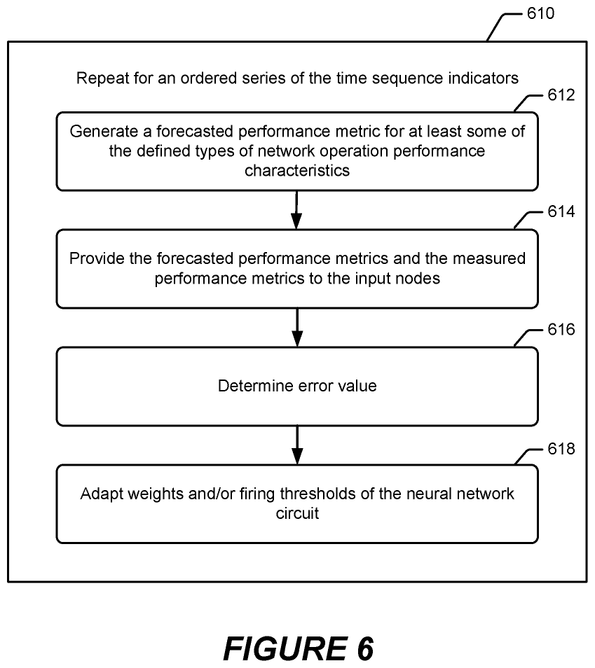

FIG. 6 is a flowchart of operations that can be performed by the network management computer system 100 and, more particularly, by one or more processors performing the metric forecasting module 210 and network controller 240.

Referring to FIGS. 3 and 6, the network metrics repository 130 can store the performance metrics 200 that are measured during operation of the communications network 140 and which are correlated to time sequence indicators for defined types of network operation performance characteristics. The network metrics repository 130 can further store fault values that are correlated to the time sequence indicators and which indicate whether defined types of network operation faults have occurred. The operations 610 of FIG. 6 are repeated for an ordered series of the time sequence indicators. The operations include, for at least some of the defined types of network operation performance characteristics, generating 612 a forecasted performance metric based on extrapolating from a sequence of the measured performance metrics in the network metrics repository that are for the type of network operation performance characteristic and that correlate to some of the time sequence indicators that precede the time sequence indicator in the ordered series. The operations further include providing 614 to the input nodes “I” in input layer 310 of the neural network circuit 120 the forecasted performance metrics and the measured performance metrics that are correlated to the time sequence indicator in the ordered series. The operations further include determining 616 an error value based on comparison of an output value of the output node 330 of the neural network circuit 120 to at least one of the fault values from the network metrics repository 130 that is correlated to the time sequence indicator in the ordered series. The operations further include adapting 618 weights and/or firing thresholds, which are used by at least the input nodes “I” in input layer 310 of the neural network circuit 120 to generate outputs to the combining nodes of a first one of the sequence of the hidden layers, to reduce the error value.

The network controller 240 can then operate to control operation of one or more of the network nodes 142 of the communications network 140 based on further output of the output node 330 of the neural network circuit 120. The output node 330 provides the further output responsive to processing through the input nodes “I” of the neural network circuit 120 a stream of measured performance metrics and forecasted performance metrics that are obtained during operation of the communication network 140.

In one embodiment, the metric forecasting module 210 operates, for one of the defined types of the network operation faults, to identify parameters of a mathematical relationship forming a trend through a historical sequence of the measured performance metrics in the network metrics repository 130 that are correlated to the time sequence indicators in the ordered series that start before and continue to an occurrence of the one of the defined types of the network operation faults. Then, for at least some of the defined types of network operation performance characteristics that correlate to a time sequence indicator at an occurrence of the one of the defined types of the network operation faults, the metric forecasting module 210 generates a forecasted performance metric using the parameters of the mathematical relationship to extrapolate from a sequence of the measured performance metrics in the network metrics repository 130 that are for the type of network operation performance characteristic and that correlate to some of the time sequence indicators that precede the time sequence indicator in the ordered series at the occurrence of the one of the defined types of the network operation faults.

For example, the forecasting algorithm may be tuned for input buffer utilization, output buffer utilization, or memory utilization. Another forecasting algorithm can be tuned for another one of the defined types of the network operation faults, such as bit error rate or dropped packet rate.

In a further embodiment, the metric forecasting module operates to, for another one of the defined types of the network operation faults, identify parameters of another mathematical relationship forming a trend through a historical sequence of the measured performance metrics in the network metrics repository 130 that are correlated to the time sequence indicators in the ordered series that start before and continue to an occurrence of the another one of the defined types of the network operation faults. Then, for at least some of the defined types of network operation performance characteristics that correlate to a time sequence indicator at an occurrence of the another one of the defined types of the network operation faults, the metric forecasting module 210 generates a forecasted performance metric using the parameters of the another mathematical relationship to extrapolate from a sequence of the measured performance metrics in the network metrics repository 130 that are for the type of network operation performance characteristic and that correlate to some of the time sequence indicators that precede the time sequence indicator in the ordered series at the occurrence of the another one of the defined types of the network operation faults.

Although the embodiment of FIG. 3 shows a one-to-one mapping between each type of measured or forecasted performance metric and one input node of the input layer 310, other embodiments are not limited thereto. For example, in a first embodiment, a plurality of different types of measured performance metrics can be combined to generate a combined performance metric that is input to one input node of the input layer 310. Alternatively or additionally, in a second embodiment, a plurality of measured performance metrics over time for a single type of measured performance metric for one of the network nodes 142 can be combined to generate a combined performance metric that is input to one input node of the input layer 310. In the second embodiment, when different types of performance metrics are generated at different rates and/or are received from different ones of the network nodes 142 at different rates, some of the performance metrics that are received at higher rates may be combined to generate a statistical representation thereof which is then provided to the input nodes at a lower rate that is the same as for other performance metrics which are generated that lower rate.

In one illustrative embodiment, an operation to provide to the input nodes “I” of the neural network circuit 120 the forecasted performance metrics and the measured performance metrics, includes combining a plurality of the measured performance metrics at time sequence indicators earlier than a present time sequence indicator to generate an aggregated measured performance metric, and providing the aggregated measured performance metric to the neural network circuit 120 as one of the measured performance metrics 200. A number of the measured performance metrics that are combined to generate the aggregated measured performance metric can be determined based an epoch cycle time of the neural network circuit 120.

In another illustrative embodiment, the processor of system 100 combines a plurality of the measured performance metrics in a stream during operation of the communication network to generate an aggregated measured performance metric. A forecasted aggregate performance metric is generated based on extrapolating from a series of aggregated measured performance metrics in the stream during earlier operation of the communication network. Operation of the communication network 140 is then based on output of the output node of the output layer 330 of the neural network circuit 120 while processing through the input nodes “I” of the input layer 310 of the neural network circuit 120 the aggregated measured performance and forecasted aggregate performance metric. A number of the measured performance metrics in the stream that are combined to generate the aggregated measured performance metric can be determined based an epoch cycle time of the neural network circuit.

FIG. 5 is a block diagram and data flow diagram of a neural network circuit 120 that can be used in the network management computer system 100 to generate a network operation fault prediction 500 and perform feedback training of the node weights and firing thresholds 510 of the input layer 310, the neural network layer 320 and the output layer 330.

Referring to FIG. 5, the neural network circuit 120 includes the input layer 310 having a plurality of input nodes, the sequence of neural network hidden layers 320 each including a plurality of weight nodes, and the output layer 330 including an output node. In the particular non-limiting example of FIG. 5, the input layer 310 includes input nodes I₁ to I_{N} (where N is any plural integer). The measured performance metrics 200 and the forecasted performance metrics 300 are provided to different ones of the input nodes I₁ to I_{N}. A first one of the sequence of neural network hidden layers 320 includes weight nodes N_{1L1} (where “1L1” refers to a first weight node on layer one) to N_{XL1} (where X is any plural integer). A last one (“Z”) of the sequence of neural network hidden layers 320 includes weight nodes N_{1LZ} (where Z is any plural integer) to N_{YLZ} (where Y is any plural integer). The output layer 330 includes an output node O.

The neural network circuit 120 of FIG. 5 is an example that has been provided for ease of illustration and explanation of one embodiment. Other embodiments may include any non-zero number of input layers having any non-zero number of input nodes, any non-zero number of neural network layers having a plural number of weight nodes, and any non-zero number of output layers having any non-zero number of output nodes. The number of input nodes can be selected based on the number of measured performance metrics 200 and forecasted performance metrics 300 that are to be simultaneously processed, and the number of output nodes can be similarly selected based on the number of network operation fault prediction values that are to be simultaneously generated therefrom.

The neural network model 120 can be operated to process different measured performance metrics 200 and forecasted performance metrics 300, during a training mode by the training module 220 and/or during the run-time mode 230 run-time 230, through different inputs (e.g., input nodes I₁ to I_{N}) of the neural network model 120. Measured performance metrics 200 that can be simultaneously processed through different input nodes I₁ to I_{N} may include at least two of the following:
1) network node input buffer memory utilization;
2) network node output buffer memory utilization;
3) network node input packet traffic bit error rate;
4) network node output packet traffic bit error rate;
5) network node input traffic dropped packet rate;
6) network node output traffic dropped packet rate;
7) network node processor utilization;
8) network node code memory utilization;
9) network node packet processing memory utilization; and
10) network communication latency.

Correspondingly, the metric forecasting module 210 can output forecasted values from the measured performance metrics 200 that are processed through different ones of the input nodes nodes I₁ to I_{N} which are not used to process the measured performance metrics 200.

The neural network circuit 120 operates the input nodes of the input layer 310 to each receive different forecasted performance metrics 300 and the measured performance metrics 200 that are correlated to the time sequence indicator in the ordered series. Each of the input nodes multiply metric values that are input by a weight that is assigned to the input node to generate a weighted metric value. When the weighted metric value exceeds a firing threshold assigned to the input node, the input node then provides the weighted metric value to the combining nodes of the first one of the sequence of the hidden layers 320. The input node does not output the weighted metric value if and until the weighted metric value exceeds the assigned firing threshold.

During run-time and training mode, the interconnected structure between the input nodes 310, the weight nodes of the neural network hidden layers 320, and the output nodes 330 may cause the characteristics of each inputted performance metric to influence the network operation fault prediction 500 generated for all of the other inputted performance metrics that are simultaneously processed.

A training module 510 uses feedback of stored fault values and stored performance values from the network metrics repository 130 to adjust the weights and the firing weights of the input nodes of the input layer 310, and may further adjust the weights and the firing weights of the hidden layer nodes of the hidden layers 320 and the output node of the output layer 330. The training module 510 may also adjust the weights and the firing weights responsive to real-time feedback 260 of the network operation fault prediction values 500 output by the output node of the output layer 330.

Furthermore, the neural network circuit 120 operates the combining nodes of the first one of the sequence of the hidden layers 320 using weights that are assigned thereto to multiply and mathematically combine weighted metric values provided by the input nodes to generate combined metric values, and when the combined metric value generated by one of the combining nodes exceeds a firing threshold assigned to the combining node to then provide the combined metric value to the combining nodes of a next one of the sequence of the hidden layers 320.

Furthermore, the neural network circuit 120 operates the combining nodes of a last one of the sequence of hidden layers 320 using weights that are assigned thereto to multiply and combine the combined metric values provided by a plurality of combining nodes of a previous one of the sequence of hidden layers to generate combined metric values, and when the combined metric value generated by one of the combining nodes exceeds a firing threshold assigned to the combining node to then provide the combined metric value to the output node of the output layer 330.

Finally, the output node of the output layer 330 is then operated to combine the combined metric values to generate the output value used for determining the error value that is correlated to the time sequence indicator in the ordered series.

In further embodiments, the network metrics repository 130 stores the performance metrics that are measured during operation of the communication network 140 and which are correlated to time sequence indicators for defined types of network operation performance characteristics 250, and the network metrics repository 130 further stores fault values that are correlated to the time sequence indicators and which indicate whether defined types of network operation faults have occurred.

In one illustrative embodiment, the neural network circuit 120 operates the input nodes of the input layer to each receive different ones of the forecasted performance metrics 200 and the measured performance metrics 300 that are correlated to the time sequence indicator in the ordered series. Each of the input nodes multiplies metric values that are inputted are multiplied by a weight that is assigned to the input node and are combined to generate a weighted metric value. If and when the weighted metric value exceeds a firing threshold assigned to the input node, the weighted metric value is then outputted to the combining nodes of the first one of the sequence of the hidden layers.

The neural network circuit 120 operates combining nodes of the first one of the sequence of the hidden layers using weights that are assigned thereto to multiply and combine weighted metric values provided by the input nodes to generate combined metric values, and if and when the combined metric value generated by one of the combining nodes exceeds a firing threshold assigned to the combining node to then provide (output) the combined metric value to the combining nodes of a next one of the sequence of the hidden layers. The neural network circuit 120 also operate the combining nodes of a last one of the sequence of hidden layers using weights that are assigned thereto to multiply and combine the combined metric values provided by a plurality of combining nodes of a previous one of the sequence of hidden layers to generate combined metric values, and when the combined metric value generated by one of the combining nodes exceeds a firing threshold assigned to the combining node to then provide (output) the combined metric value to the output node of the output layer. The neural network circuit 120 operates the output node of the output layer to combine the combined metric values provided by the combining nodes of the last one of the sequence of hidden layers to generate the output value used for determining the error value that is correlated to the time sequence indicator in the ordered series.

Volatility in changes to the performance metrics 200 and/or the forecasted performance metrics 300 which are input to the neural network circuit 120 can cause instability in the training operation of the neural network circuit 120. For example, having high volatility in the input metrics can cause the neural network circuit 120 to become overly sensitive during training to spurious data that has a low causal relationship to network operation faults. Stability of the training operation in the neural network circuit 120 can be improved by decreasing a rate of change in the weights and/or firing thresholds further based on the determined volatility increasing and increasing the rate of change in the weights and /or firing thresholds further based on determined volatility decreases.

In an illustrative embodiment, the operation 406 (FIG. 4) to adapt the weights and/or firing thresholds, which are used by at least the input nodes of the neural network circuit 120 to generate outputs to the combining nodes of a first one of the sequence of the hidden layers, to reduce the error value. The adaptation operation can include determining volatility in a sequence of the measured performance metrics in the network metrics repository 130 that are for one type of network operation performance characteristic and that correlate to some time sequence indicators that precede a present time sequence indicator in an ordered series, and then adapting the weights and/or firing thresholds further based on the determined volatility in the sequence of the measured performance metrics.

The operation 406 (FIG. 4) to adapt the weights and/or firing thresholds further based on the determined volatility in the sequence of the measured performance metrics, can include decreasing a rate of change in the weights and/or firing thresholds further based on the determined volatility increasing. In contrast, operation 406 can increase a rate of change in the weights and/or firing thresholds further based on the determined volatility decreasing.

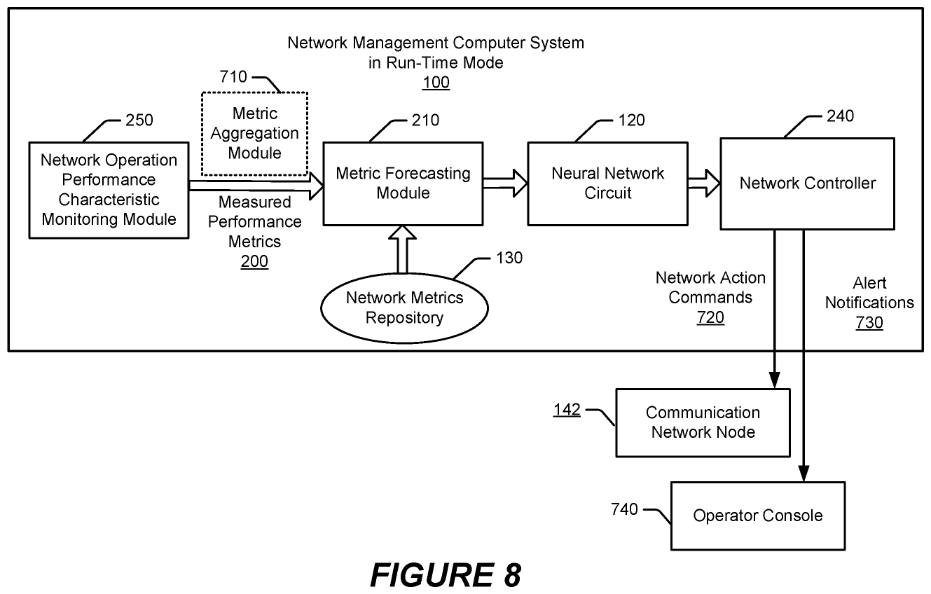

FIG. 8 is a block diagram of operational modules and related circuits and controllers of the network management computer system 100 that are configured to operate during the run-time mode 230.

Referring to FIG. 8, the network operation performance characteristic monitoring module 250 outputs measured performance metrics 200 to the metric forecasting module 210. A metric aggregation module 710 may combine a plurality of the measured performance metrics to generate an aggregated measured performance metric, such as explained above in accordance with various embodiments. The metric forecasting module 210 can operate on a stream of the incoming measure performance metrics and/or from earlier measured performance metrics retrieved from the network metrics repository 130. Metric forecasting module 210 outputs the forecasted performance metrics 300 and the measured performance metrics 200 to the neural network circuit 120. The network operation fall prediction 500 (FIG. 5) from the output node of the neural network circuit 120 is provided to the network controller 240. The network controller 240 can generate network action commands 720 which are communicated to a selected one of the communication network nodes 142 which is predicted based on the fault prediction 500 to have a near-term future problematic operation.

Alternatively or additionally, the network controller 240 can generate alert notification 730 which are communicated to the operator console 740 to, for example, alert a network operator that an identified one of the network nodes 142 is predicted based on the production 500 to have a near-term future problematic operation. The operator console 740 may automatically perform, or perform responsive to a command from a human operator, operations to shift applications from the identified network node 142 to another one of the network nodes 142′, operations to reboot identified network node 142, operations to swap out the identified network node 142 with another hot-standby other one of the network nodes 142′, operations to physically replace the identified network node 142 with another wraps operationally equivalent network node, etc.

Aspects of the present disclosure have been described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A network management computer system comprising:
a network metrics repository that stores performance metrics that are measured during operation of a communication network, the network metrics repository further storing fault values which indicate whether defined types of network operation faults have occurred;
a neural network circuit having an input layer having input nodes, a sequence of hidden layers each having a plurality of combining nodes, and an output layer having an output node; and
at least one processor coupled to the network metrics repository and to the neural network circuit, the at least one processor configured to:
generate forecasted performance metrics based on extrapolating from measured performance metrics in the network metrics repository;
provide to the input nodes of the neural network circuit the forecasted performance metrics and the measured performance metrics;
adapt weights and/or firing thresholds that are used by at least the input nodes of the neural network circuit responsive to output of the output node of the neural network circuit; and
control operation of the communication network based on output of the output node of the neural network circuit, the output node providing the output responsive to processing through the input nodes of the neural network circuit a stream of measured performance metrics and forecasted performance metrics that are obtained during operation of the communication network.

2. The network management computer system of claim 1, wherein:
the network metrics repository stores the performance metrics that are measured during operation of the communication network and which are correlated to time sequence indicators for defined types of network operation performance characteristics, the network metrics repository further stores fault values that are correlated to the time sequence indicators and which indicate whether defined types of network operation faults have occurred;
the at least one processor is further configured to: repeat operations for an ordered series of the time sequence indicators to:
for at least some of the defined types of network operation performance characteristics, generate a forecasted performance metric based on extrapolating from a sequence of the measured performance metrics in the network metrics repository that are for the type of network operation performance characteristic and that correlate to some of the time sequence indicators that precede the time sequence indicator in the ordered series;
provide to the input nodes of the neural network circuit the forecasted performance metrics and the measured performance metrics that are correlated to the time sequence indicator in the ordered series;
determine an error value based on comparison of an output value of the output node of the neural network circuit to at least one of the fault values from the network metrics repository that is correlated to the time sequence indicator in the ordered series; and
adapt weights and/or firing thresholds, which are used by at least the input nodes of the neural network circuit to generate outputs to the combining nodes of a first one of the sequence of the hidden layers, to reduce the error value; and
control operation of the communication network based on further output of the output node of the neural network circuit, the output node providing the further output responsive to processing through the input nodes of the neural network circuit a stream of measured performance metrics and forecasted performance metrics that are obtained during operation of the communication network.

3. The network management computer system of claim 2, wherein the at least one processor is further configured to:
for one of the defined types of the network operation faults, identify parameters of a mathematical relationship forming a trend through a historical sequence of the measured performance metrics in the network metrics repository that are correlated to the time sequence indicators in the ordered series that start before and continue to an occurrence of the one of the defined types of the network operation faults,
wherein, for at least some of the defined types of network operation performance characteristics that correlate to a time sequence indicator at an occurrence of the one of the defined types of the network operation faults, a forecasted performance metric is generated using the parameters of the mathematical relationship to extrapolate from a sequence of the measured performance metrics in the network metrics repository that are for the type of network operation performance characteristic and that correlate to some of the time sequence indicators that precede the time sequence indicator in the ordered series at the occurrence of the one of the defined types of the network operation faults.

4. The network management computer system of claim 3, wherein the at least one processor is further configured to:
for another one of the defined types of the network operation faults, identify parameters of another mathematical relationship forming a trend through a historical sequence of the measured performance metrics in the network metrics repository that are correlated to the time sequence indicators in the ordered series that start before and continue to an occurrence of the another one of the defined types of the network operation faults,
wherein, for at least some of the defined types of network operation performance characteristics that correlate to a time sequence indicator at an occurrence of the another one of the defined types of the network operation faults, a forecasted performance metric is generated using the parameters of the another mathematical relationship to extrapolate from a sequence of the measured performance metrics in the network metrics repository that are for the type of network operation performance characteristic and that correlate to some of the time sequence indicators that precede the time sequence indicator in the ordered series at the occurrence of the another one of the defined types of the network operation faults.

5. The network management computer system of claim 2, wherein the neural network circuit is configured to:
operate the input nodes of the input layer to each receive different ones of the forecasted performance metrics and the measured performance metrics that are correlated to the time sequence indicator in the ordered series, each of the input nodes multiplying metric values that are inputted by a weight that is assigned to the input node to generate a weighted metric value, and when the weighted metric value exceeds a firing threshold assigned to the input node to then provide the weighted metric value to the combining nodes of the first one of the sequence of the hidden layers;
operate the combining nodes of the first one of the sequence of the hidden layers using weights that are assigned thereto to multiply and combine weighted metric values provided by the input nodes to generate combined metric values, and when the combined metric value generated by one of the combining nodes exceeds a firing threshold assigned to the combining node to then provide the combined metric value to the combining nodes of a next one of the sequence of the hidden layers;
operate the combining nodes of a last one of the sequence of hidden layers using weights that are assigned thereto to multiply and combine the combined metric values provided by a plurality of combining nodes of a previous one of the sequence of hidden layers to generate combined metric values, and when the combined metric value generated by one of the combining nodes exceeds a firing threshold assigned to the combining node to then provide the combined metric value to the output node of the output layer; and
operate the output node of the output layer to combine the combined metric values provided by the combining nodes of the last one of the sequence of hidden layers to generate the output value used for determining the error value that is correlated to the time sequence indicator in the ordered series.

6. The network management computer system of claim 2, wherein the adaptation of weights and/or firing thresholds, which are used by at least the input nodes of the neural network circuit to generate outputs to the combining nodes of a first one of the sequence of the hidden layers, to reduce the error value, comprises:
determining volatility in a sequence of the measured performance metrics in the network metrics repository that are for one type of network operation performance characteristic and that correlate to some time sequence indicators that precede a present time sequence indicator in an ordered series;
adapting the weights and/or firing thresholds further based on the determined volatility in the sequence of the measured performance metrics.

7. The network management computer system of claim 6, wherein the adaptation of the weights and/or firing thresholds further based on the determined volatility in the sequence of the measured performance metrics, comprises:
decreasing a rate of change in the weights and/or firing thresholds further based on the determined volatility increasing; and
increasing a rate of change in the weights and/or firing thresholds further based on the determined volatility decreasing.

8. The network management computer system of claim 2, wherein the communication network comprises at least one network node that receives and forwards communication packets, the defined types of network operation performance characteristics comprise at least two of the following:
network node input buffer memory utilization;
network node output buffer memory utilization;
network node input packet traffic bit error rate;
network node output packet traffic bit error rate;
network node input traffic dropped packet rate;
network node ouput traffic dropped packet rate;
network node processor utilization;
network node code memory utilization;
network node packet processing memory utilization; and
network communication latency.

9. The network management computer system of claim 1, wherein an operation to provide to the input nodes of the neural network circuit the forecasted performance metrics and the measured performance metrics, comprises:
combine a plurality of the measured performance metrics at time sequence indicators earlier than a present time sequence indicator to generate an aggregated measured performance metric; and
providing the aggregated measured performance metric to the neural network circuit as one of the measured performance metrics.

10. The network management computer system of claim 9, wherein a number of the measured performance metrics that are combined to generate the aggregated measured performance metric is determined based an epoch cycle time of the neural network circuit.

11. The network management computer system of claim 1, wherein the at least one processor is further configured to:
combine a plurality of the measured performance metrics in a stream during operation of the communication network to generate an aggregated measured performance metric;
generate a forecasted aggregate performance metric based on extrapolating from a series of aggregated measured performance metrics in the stream during earlier operation of the communication network; and
control operation of the communication network based on output of the output node of the neural network circuit while processing through the input nodes of the neural network circuit the aggregated measured performance and forecasted aggregate performance metric.

12. The network management computer system of claim 11, wherein a number of the measured performance metrics in the stream that are combined to generate the aggregated measured performance metric is determined based an epoch cycle time of the neural network circuit.

13. The network management computer system of claim 1, wherein the communication network comprises a plurality of network nodes that receive and forward communication packets, and wherein an operation to control operation of the communication network based on output of the output node of the neural network circuit while processing through the input nodes of the neural network circuit a stream of measured performance metrics and forecasted performance metrics that are obtained during operation of the communication network, comprises
shifting communication packet traffic away from one of the network nodes toward one or more other ones of the network node responsive to the measured performance metrics characterizing operation of the network node and the output of the output node of the neural network circuit indicating at least a threshold likelihood of a fault in operation of the network node.

14. The network management computer system of claim 1, wherein the communication network comprises at least one network node that receives and forwards communication packets, and wherein an operation to control operation of the communication network based on output of the output node of the neural network circuit while processing through the input nodes of the neural network circuit a stream of measured performance metrics and forecasted performance metrics that are obtained during operation of the communication network, comprises
communicating a command to a network node instructing the network node to reboot at least a portion of executable operation code of the network node, responsive to the measured performance metrics characterizing operation of the network node and the output of the output node of the neural network circuit indicating at least a threshold likelihood of a fault in operation of the network node.

15. The network management computer system of claim 1, wherein the communication network comprises at least one network node that receives and forwards communication packets, and wherein an operation to control operation of the communication network based on output of the output node of the neural network circuit while processing through the input nodes of the neural network circuit a stream of measured performance metrics and forecasted performance metrics that are obtained during operation of the communication network, comprises
communicating an alert notification toward an operator console which indicates that an identified network node has an operational fault, responsive to the measured performance metrics characterizing operation of the identified network node and the output of the output node of the neural network circuit indicating at least a threshold likelihood of a fault in operation of the identified network node.

16. A computer program product comprising:
a non-transitory computer readable storage medium having computer readable program code stored in the medium and when executed by at least one processor of a network management computer system causes the network management computer system to perform operations comprising:
accessing a network metrics repository to retrieve performance metrics that are measured during operation of a communication network, and to retrieve fault values which indicate whether defined types of network operation faults have occurred;
generating forecasted performance metrics based on extrapolating from the measured performance metrics;
providing to input nodes of a neural network circuit the forecasted performance metrics and the measured performance metrics;
adapting weights and/or firing thresholds that are used by at least the input nodes of the neural network circuit responsive to output of an output node of the neural network circuit; and
controlling operation of the communication network based on output of the output node of the neural network circuit, the output node providing the output responsive to processing through the input nodes of the neural network circuit a stream of measured performance metrics and forecasted performance metrics that are obtained during operation of the communication network.

17. The computer program product of claim 16, wherein the performance metrics are measured during operation of the communication network and are correlated to time sequence indicators for defined types of network operation performance characteristics, the fault values are correlated to the time sequence indicators and indicate whether defined types of network operation faults have occurred, and the operations by the at least one processor executing the computer readable program code further comprise:
repeating operations for an ordered series of the time sequence indicators to:
for at least some of the defined types of network operation performance characteristics, generate a forecasted performance metric based on extrapolating from a sequence of the measured performance metrics retrieved from the network metrics repository that are for the type of network operation performance characteristic and that correlate to some of the time sequence indicators that precede the time sequence indicator in the ordered series;
provide to the input nodes of the neural network circuit the forecasted performance metrics and the measured performance metrics that are correlated to the time sequence indicator in the ordered series;
determine an error value based on comparison of an output value of the output node of the neural network circuit to at least one of the fault values from the network metrics repository that is correlated to the time sequence indicator in the ordered series; and
adapt weights and/or firing thresholds, which are used by at least the input nodes of the neural network circuit to generate outputs to the combining nodes of a first one of the sequence of the hidden layers, to reduce the error value; and
controlling operation of the communication network based on further output of the output node of the neural network circuit, the output node providing the further output responsive to processing through the input nodes of the neural network circuit a stream of measured performance metrics and forecasted performance metrics that are obtained during operation of the communication network.

18. The computer program product of claim 17, wherein the operations by the at least one processor executing the computer readable program code further comprise:
for one of the defined types of the network operation faults, identifying parameters of a mathematical relationship forming a trend through a historical sequence of the measured performance metrics retrieved from the network metrics repository that are correlated to the time sequence indicators in the ordered series that start before and continue to an occurrence of the one of the defined types of the network operation faults,
wherein, for at least some of the defined types of network operation performance characteristics that correlate to a time sequence indicator at an occurrence of the one of the defined types of the network operation faults, generating a forecasted performance metric using the parameters of the mathematical relationship to extrapolate from a sequence of the measured performance metrics in the network metrics repository that are for the type of network operation performance characteristic and that correlate to some of the time sequence indicators that precede the time sequence indicator in the ordered series at the occurrence of the one of the defined types of the network operation faults.

19. The computer program product of claim 16, wherein the operations by the at least one processor executing the computer readable program code further comprise:
combining a plurality of the measured performance metrics in a stream during operation of the communication network to generate an aggregated measured performance metric;
generating a forecasted aggregate performance metric based on extrapolating from a series of aggregated measured performance metrics in the stream during earlier operation of the communication network; and
controlling operation of the communication network based on output of the output node of the neural network circuit while processing through the input nodes of the neural network circuit the aggregated measured performance and forecasted aggregate performance metric,
wherein a number of the measured performance metrics in the stream that are combined to generate the aggregated measured performance metric is determined based an epoch cycle time of the neural network circuit.

20. A method by a network management computer system comprising:
accessing a network metrics repository to retrieve performance metrics that are measured during operation of a communication network, and to retrieve fault values which indicate whether defined types of network operation faults have occurred;
generating forecasted performance metrics based on extrapolating from the measured performance metrics;
providing to input nodes of a neural network circuit the forecasted performance metrics and the measured performance metrics;
adapting weights and/or firing thresholds that are used by at least the input nodes of the neural network circuit responsive to output of an output node of the neural network circuit; and
controlling operation of the communication network based on further output of the output node of the neural network circuit, the output node providing the further output responsive to processing through the input nodes of the neural network circuit a stream of measured performance metrics and forecasted performance metrics that are obtained during operation of the communication network.
